(19) United States
(12) Patent Application Publication
(10) Pub. No.: US 2006/0108704 A1
(43) Pub. Date: May 25, 2006

(54) Device and method for graphic transfer for packaging and other 3-D items

(76) Inventors: Paul Urban Geiwald, San Diego, CA (US); Shun Chuen "Rick" Mok, Tsuen Wan (CN); Chit-Ho "Fred" Tam, Yuen Long (CN)

Correspondence Address: CHRISTIE, PARKER & HALE, LLP, PO BOX 7068, PASADENA, CA, 91109-7068, US

(21) Appl. No.: 11/248,772

(22) Filed: Oct. 11, 2005

Related U.S. Application Data
(60) Provisional application No. 60/618,090, filed on Oct. 11, 2004.

(51) Int. Cl. C04B 41/00

(52) U.S. Cl. 264/132; 206/459.5; 700/118

(57) ABSTRACT

A device and method for graphic transfers for packaging and other 3-D items. In the method, a sheet of plastic material is printed with graphical indicia that have been modified to compensate for distortions that take place when the plastic sheet is molded. When the plastic sheet with the modified graphical indicia is molded into the 3-D item, the graphical indicia will be returned to its unaltered form. The machine has upper and lower mold bodies that when brought together to a closed position will tightly seal a plastic sheet therebetween to define an upper airspace and a lower airspace. The machine has a heating source and a mold in the lower mold body. The machine is usable to mold plastics sheets bearing modified graphical indicia into 3-D items where the graphical indicia is returned to its unmodified state.

### CROSS-REFERENCE TO RELATED APPLICATION

This patent application claims the benefit of U.S. provisional patent application No. 60/618,090, filed on Oct. 11, 2004.

### BACKGROUND

This invention is related to the field of packaging, containers, and other 3-D items, and more particularly to a device and method for forming packaging, containers and other 3-D items having non-flat and non-cylindrical surfaces with graphical indicia printed thereon, and the non-flat and non-cylindrical packaging bearing printed graphical indicia, and the packaging formed thereby.

Presently, manufacturers use several major methods to display graphical indicia including artwork, text and other images in or on plastic packaging, containers and other 3-D items for consumer and commercial goods. These methods include the following: (A) Providing vacuum formed blister box (or as often called “clam shells”) with printed insert cards. This type of packaging has the inherent limitation that it must accommodate inevitably flat insert paper cards—hence almost all designed packaging shapes have a flat back regardless of the shape of the product it contains. (B) Pad or roll printing with the art directly printed onto containers with a cylindrical shape, e.g., certain cylindrical shampoo bottles, etc. These methods have the limitations that the shape must be perfectly cylindrical for the roll and/or pad printing process to function properly, and therefore these methods are not suited for use with a variety of non-round products/objects. (C) Utilizing a sticker for the art & copy for surfaces that are either flat or round plastic shapes, (e.g. some shampoo bottles, etc.). The limitation of this type of packaging is that stickers can only be applied consistently over fairly even surface areas. Moreover, if the packaging has flat faces, manufacturers may need to apply more than one sticker per package to provide art on both the front and back of the package, which results in sides often being missed. (D) Printing onto a flat plastic sheet, building fold lines into the plastic sheet, and then folding the sheet into a rectangular box. One limitation of this method is that the shape being formed is largely limited to shapes with flat sides. Moreover, this packaging tends to be brittle and less rigid than vacuum formed containers. Indeed, the plastic material needs to be thin enough for folding purposes yet thick enough to provide adequate structural integrity. (E) Forming stretch blow molded containers, such as water bottles, that are blown up much like a balloon from a small “mouth piece” and then secured with a knot at the bottom where the bottle is closed. On these structures one will often find vinyl sleeves as the material for the printed art and copy. (F) Tampo printing, where an ink transfer pad having a surface contour that is complementary to an object to be printed, is used for printing regular and some irregular shaped objects. However, tampo printing may not be practical in certain circumstances, such as when a user wishes to print the inside surface of concave objects where the printing pad cannot access the surface to be printed.

As a result of the limitations with these prior methods, the shapes and designs of most plastic packaging are dictated by the practical limitations of needing to display art & copy on packaging that have flat surfaces or surfaces that are cylindrical. It therefore is problematic to provide printed packaging that has curvature in more than one plane (e.g. egg-shaped containers, spherical shapes), irregular surfaces (e.g., rippled surface), and other complex shapes that are not suitable for printing or carrying graphical indicia by the above described methods.

These design limitations lead to a compromise in the functionality of currently available packaging. Oftentimes, the structure of the packaging being designed is dictated by considerations of accommodating the art & copy (and sometimes anti-shoplifting concerns) rather than the object of carrying the goods. If designers are free to design packaging to ideally suit the object it is to contain, rather than being constrained by considerations of applying the art & copy, then the options and variety of shapes and forms of packaging structures can be dramatically increased.

There accordingly remains a need for a device and method of manufacturing thermoformed packaging with graphic indicia printed thereon, which method is suitable for any shaped packaging that can be formed by thermoforming, including packaging with non-flat and non-cylindrical surfaces that are to carry graphical indicia.

### BRIEF DESCRIPTION OF THE DRAWINGS

FIG. 1 is a flowchart showing an exemplary method of forming packaging having printing formed thereon.

FIG. 2 is a front view showing exemplary 3-D packaging or other items with non-flat and non-cylindrical surfaces with printing formed thereon.

FIG. 3 is a top view of an exemplary sheet of moldable material.

FIG. 4 is a top view of a sheet of moldable material of FIG. 3, but printed with a calibration pattern.

FIG. 5 is a detail showing a few grid lines before being distorted by forming the moldable sheet into the prototype packaging.

FIG. 6 is a detail showing the grid lines of FIG. 5 after being distorted when the moldable sheet is formed into the prototype packaging.

FIG. 7 is a front partially exposed perspective view of an exemplary machine for forming packaging having printing formed thereon.

FIGS. 8-13 are diagrammatic cross sectional views illustrating the inside of an exemplary upper and lower mold bodies of the machine for forming concave packaging or other 3-D items having printing formed thereon, with FIG. 8 showing the machine before a flat moldable sheet is inserted therein.

FIG. 9 is a diagrammatic cross-sectional view illustrating the inside of the exemplary upper and lower mold bodies of FIG. 8 with a flat moldable sheet inserted between the upper and lower mold bodies and with heat being applied.

FIG. 10 is a diagrammatic cross-sectional view illustrating the inside of the exemplary upper and lower mold bodies of FIG. 9 with air pressure introduced into the upper mold to deform the sheet of evenly heated flat moldable sheet into general conformity to a mold in the lower mold body.

FIG. 11 is a diagrammatic cross sectional view illustrating the inside of the exemplary upper and lower mold bodies of FIG. 10 with air pressure further introduced into the upper mold body and vacuum applied to the lower mold body to completely deform the sheet of evenly heated flat moldable sheet into complete conformity to the mold in the lower mold body.

FIG. 12 is a diagrammatic cross sectional view illustrating the inside of the exemplary upper and lower mold bodies of FIG. 10 with air pressure released from the upper mold body.

FIG. 13 is a diagrammatic view illustrating the inside of the upper and lower mold bodies of FIG. 10 with the upper and lower mold bodies separated and air being blown on the now completed molded 3-D item to cool it.

FIGS. 14-20 are diagrammatic cross sectional views illustrating the inside of an exemplary upper and lower mold bodies of the machine for forming convex packaging having printing formed thereon, with FIG. 14 showing the upper and lower mold bodies before a flat moldable sheet is inserted therein and with its convex mold in a lowered position.

FIG. 15 is a diagrammatic cross sectional view illustrating the inside of the exemplary upper and lower mold bodies of FIG. 14 with a flat moldable sheet inserted between the machine's upper and lower molds and with heat being applied.

FIG. 16 is a diagrammatic cross sectional view illustrating the inside of the exemplary upper and lower mold bodies of the machine of FIG. 14 with air pressure introduced into the lower mold body and air released from the upper mold body to deform the evenly heated flat moldable sheet upwardly into a generally convexly curved plastic sheet.

FIG. 17 is a diagrammatic cross sectional view illustrating the inside of the exemplary upper and lower mold bodies of FIG. 10 with the convex die raised upwardly into contact with the convexly curved moldable sheet and with a vacuum starting to be applied in the lower mold.

FIG. 18 is a diagrammatic cross sectional view illustrating the inside of the exemplary upper and lower mold bodies of the machine of FIG. 17 after a vacuum has been applied in the lower mold body and air pressure has been applied to the upper mold body to conform the moldable sheet to the mold.

FIG. 19 is a diagrammatic cross sectional view illustrating the inside of the exemplary upper and lower mold bodies of FIG. 17 after the moldable sheet is completely conformed to the mold with air pressure released from the upper mold body and with the upper and lower mold bodies separated and air being blown on the now completed molded 3-D item to cool it.

FIG. 20 is a diagrammatic cross sectional view illustrating the inside of the exemplary upper and lower mold bodies of FIG. 14 with the upper and lower mold bodies separated and air being blown on the now completely molded 3-D item.

FIG. 21 is a flowchart showing another exemplary method of forming packaging having printing formed thereon.

### DETAILED DESCRIPTION OF THE INVENTION

The device and method are directed to a device and method for manufacturing packaging, and are particularly well-suited to manufacturing packaging having curved and irregular contour surfaces, such as non-flat and non-cylindrical shapes, with graphical indicia printed thereon.

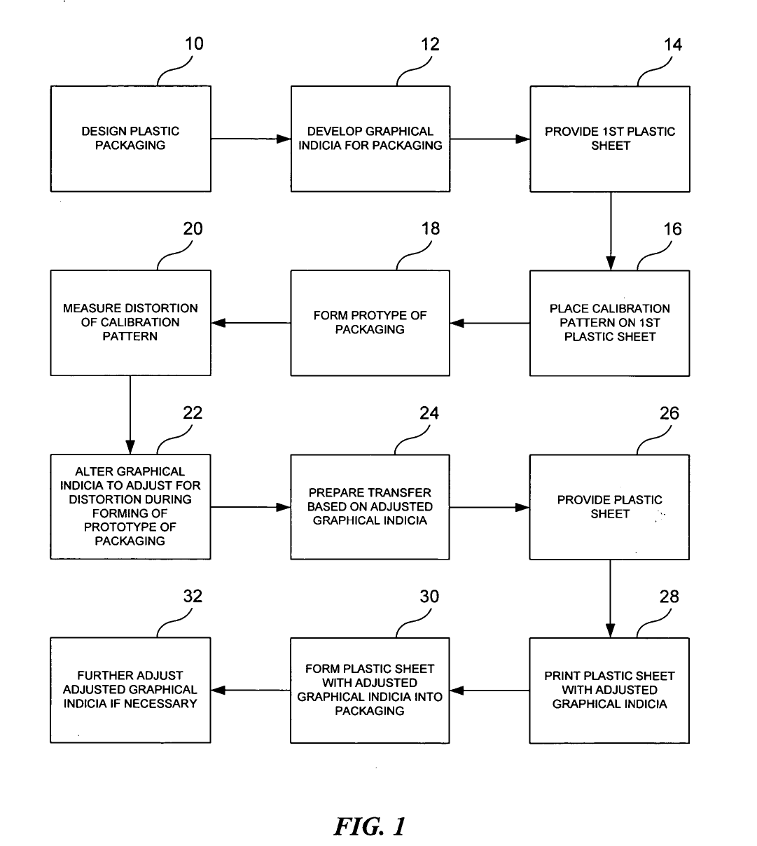

FIG. 1 is a flowchart showing an exemplary method of manufacturing packaging that bears printing. These steps are as follows:

Step 1. Design the desired plastic packaging size and shape 10. As an example, the designer may wish to design a generally egg-shaped container with printing formed thereon.

Step 2. Develop graphical indicia that are to be carried on the plastic packaging 12. By the term “graphical indicia”, the inventors mean any artwork, graphics, textual material including advertising copy, bar codes, colors, and other types of material that is to be printed on the packaging. The graphical indicia can be developed by conventional methods including by hand, by graphic design software and other known methods.

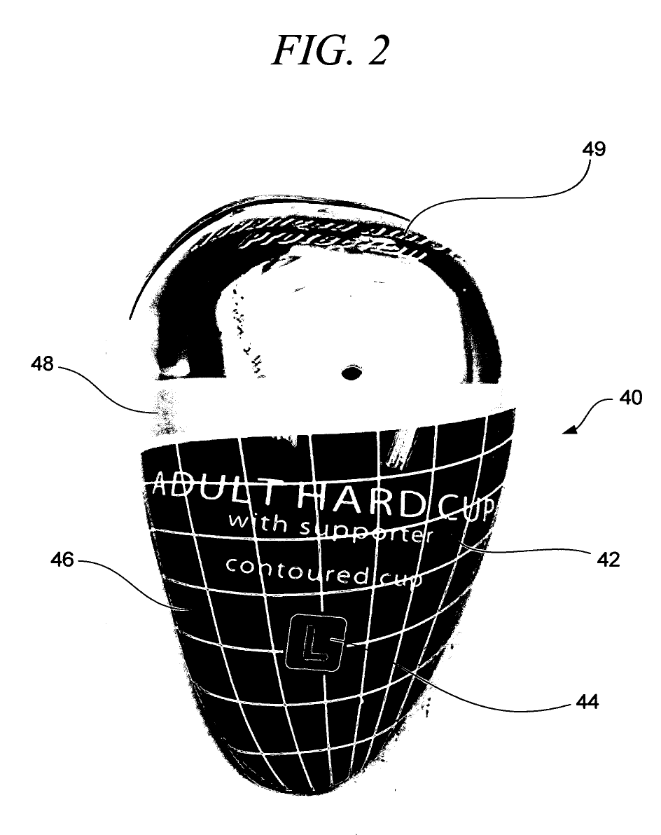

As shown in FIG. 2, which is a front plan view of packaging 40 having a generally egg shape, the packaging carries graphical indicia comprising the text, “ADULT HARD CUP with supporter contoured cup” 42 and the letter “L” in a rectangle 44, both placed on graphics comprising a dark background with white lines, and a stripe 48. Additional text “ADVANCED ATHLETIC PROTECTION” 49 also appears on packaging. As can be seen, the packaging has non-flat contours that would not be easily printable after it is formed by existing methods.

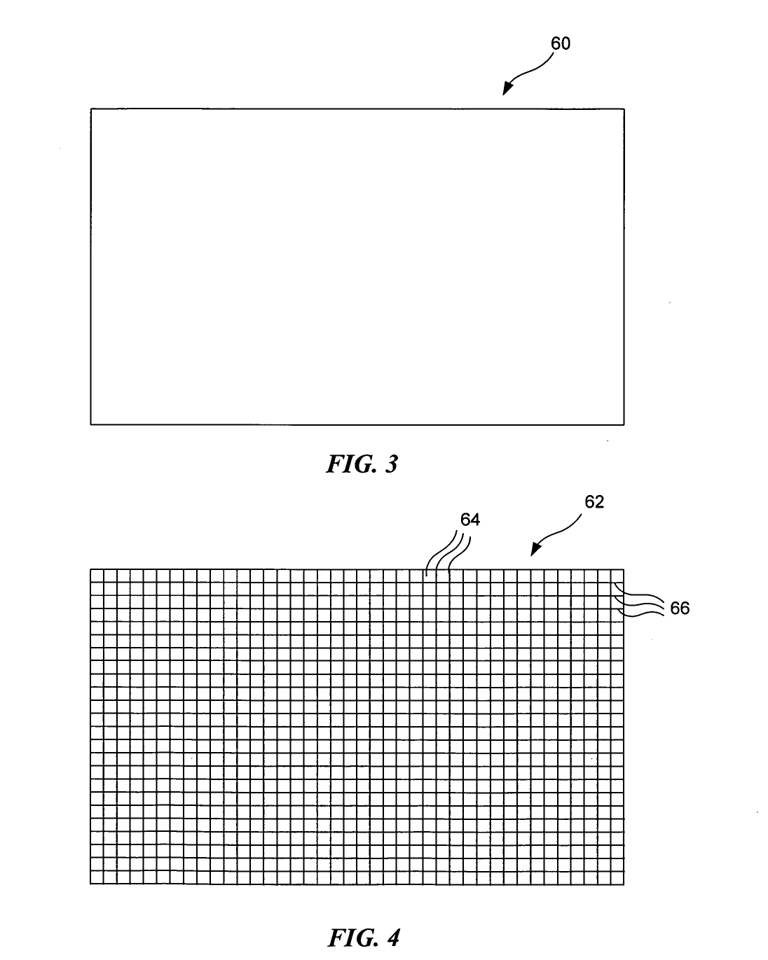

Step 3. Provide a heat moldable sheet, such as a plastic sheet with suitable dimensions (e.g. length, width and thickness) and characteristic (type of plastic, stiffness, tensile strength, color, etc.) based on structural and other design specifications and considerations of the piece(s) of the packaging to be formed. FIG. 3 is an example of such a plastic sheet 60. The moldable sheet can, for example, be a heat settable thermoplastic, including, but not limited to as polyvinyl chloride (PVC), polyesters, such as polyethylene terephthalate (PET), glycolised polyester (PETG), pentaerythritol triacrylate (PETA), crystalline polyester (CPET), acrylics, low density polyethylene (LDPE), high density polyethylene (HDPE), polypropylene (PP), styrene and polystyrene, and acrylonitrile-butadiene-styrene copolymers (ABS). As a non-limiting example, the inventors have found that sheets of PVC and PET plastic having a thickness of about 0.5 to about 0.8 mm can be utilized to form a wide variety of packaging. For example, to protect the contents of the packaging, thicker and/or stiffer sheet material or more ridges in the design may be required to form a self-supporting packaging. As noted above, the moldable sheet material should be selected based on the characteristics required of the finished packaging. Hereinafter, the term “moldable material” and “plastic” will be interchangeably used.

Step 4. Place a calibration pattern, such as a grid of thin lines or other pattern onto a first moldable sheet as a test sheet 16. Such a test sheet is shown as 62 in FIG. 4. This can be done on the front or back thereof. The calibration pattern preferably consists of thin and closely spaced apart vertical lines 64 and horizontal lines 66 on the moldable sheet 62. Spacing of about approximately 3 mm works well for many designs, but other spacings as well as other calibration patterns can be used, such as evenly spaced apart dots (not shown). The purpose of the calibration pattern is described below. A form or mold having the appropriate characteristics to shape the packaging as desired to be manufactured is provided. Typically, the form or mold will be used to form packaging with concavities adapted to hold the object(s) to be contained.

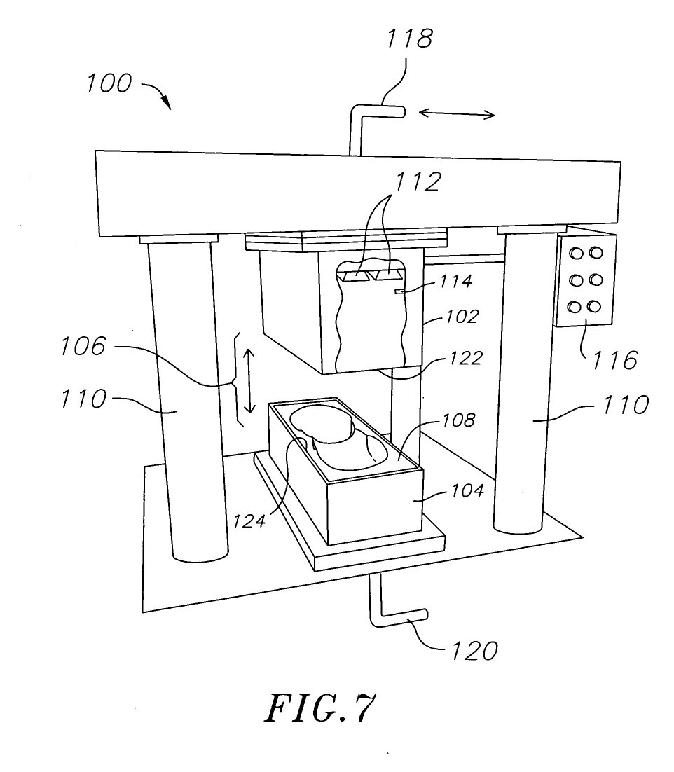

Step 5. Forming the test sheet, e.g., by a thermoforming process, such as by a vacuum forming machine by applying the air and suction force on the test sheet 18 when it is in a heated state. Also, the device of the invention, namely a device that evenly heats the plastic sheet and provide accurate and consistent molding results without changing the ink colors, which is described below in connection with FIGS. 7-20, may be used. While the calibration pattern can be printed on either a front or back side of the sheet, it is preferable, but not necessary, to apply the calibration pattern indicia to the front of the sheet so as to not scratch the calibration pattern during the forming process.

Step 6. Measure the distortion of the calibration pattern and document the distortions created by the molding process 20. This process can be conducted manually by precisely measuring the distance between the calibration lines on the molded sheet, and determining whether any stretching or shrinking of plastic or other material between the lines has taken place. Since the graphical indicia should generally distort the same way as the calibration pattern is distorted, measuring the distortions to the calibration pattern will provide a relatively accurate measure of how the graphical indicia will be distorted once it is applied to a plastic sheet and is thermoformed into the packaging. Calipers and precise rulers and other measuring devices can be used for measurements. In lieu of manually measuring the distortion, the process may be automated with scanners and other automated measurement devices.

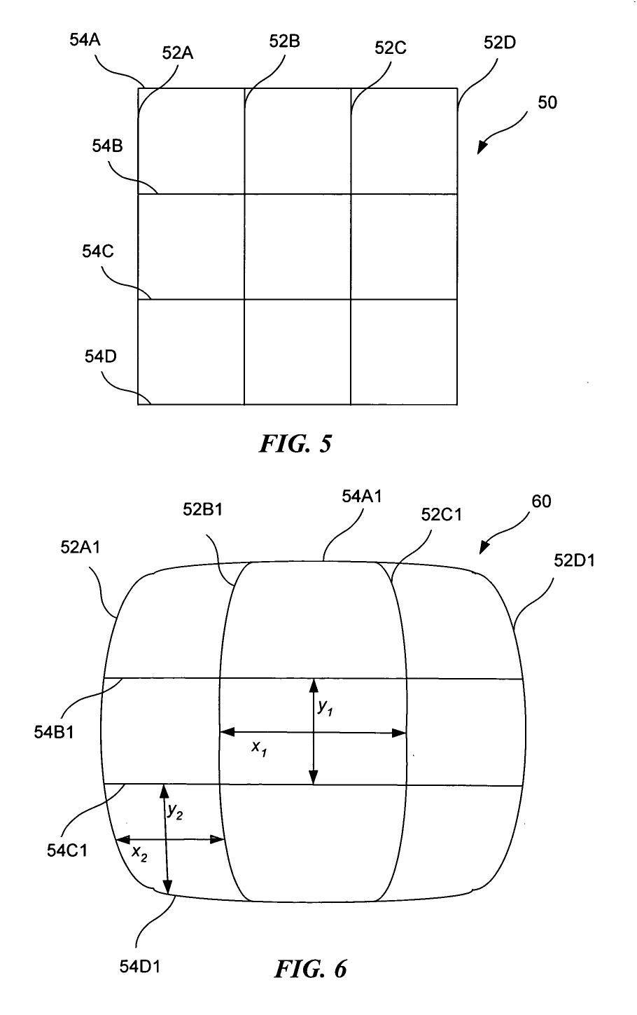

FIG. 5 shows a detail 50 of a few grid boxes created by intersection parallel vertical lines 52A, 52B, 52C and 52D and parallel horizontal lines 54A, 54B, 54C and 54D before distortion. FIG. 6 shows these same boxes and lines after they have been distorted, as vertical lines 52A1, 52B1, 52C1 and 52D1 and horizontal lines 54A1, 54B1, 54C1 and 54D1. As shown, distortion has occurred along the x and y dimensions of the lines, and any graphical indicia within the areas defined within the grid pattern would be similarly distorted. Distortions are shown in two boxes, with the measurements being x₁, y₁, and x₂, y₂, respectively. In practice, the distortion between all adjacent lines would be measured.

Turning back to FIG. 1, in Step 7, the graphical indicia is altered to adjust for distortions measured in the calibration pattern in the molded packaging 22. For computer generated designs, the graphical indicia that are to be printed onto the sheet will need to be altered. In the graphics software, one method to accomplish this is to adjust the graphical indicia according to measured calibration pattern alterations that result from the forming process. For example, if the image in one particular area (e.g., a single grid box) is stretched in an X axis by 15% and in the Y axis by 5%, then that portion of the graphical image that would correlate with that grid box will be set to be about 15% narrower in the X axis and about 5% narrower in the Y axis so that once this portion of the graphical indicia is distorted by molding, the adjusted graphical indicia design will be distorted back to the intended, undistorted graphical indicia.

The adjustment process can be done manually and the graphical indicia can be altered manually (e.g., by eye), or the process can be automated. For example, the distorted grid lines can be superimposed on the image of the unmodified graphical indicia and then the grid lines and graphical indicia can be modified so that the grid lines are returned to their unmodified state, which accomplishes the adjustment of the graphical indicia. However, further adjustments to the graphical indicia may be required. The graphical indicia that are altered is termed “adjusted graphical indicia”.

Step 8. Prepare a screen transfer based on adjustments to the distorted graphical indicia 24. For example, this can be a silk screen transfer.

Step 9. Provide moldable sheets (e.g. thermoplastics) that will be used to form the packaging 26.

Step 10. Print by silk screen or other methods the now adjusted graphical indicia onto the moldable sheets 28. The printing can be on the front or back of the sheet, but printing on the front may avoid scratching the printing during the molding process. The downside is that printing on the front may be subjected to more abrasion after it is manufactured.

Step 11. Aligning the sheet printed with the altered graphical indicia design on a thermoforming (e.g., vacuum forming) machine 30 as it was previously aligned when forming the test sheet or a machine of the invention that evenly heats the plastic sheet in the mold, retains it in consistent registration with the die and protects the colors of the finished product, as described with reference to FIG. 7-20 below. Next, the moldable sheet is molded into the shape of packaging which distorts the adjusted graphical indicia back to its undistorted graphical indicia.

Step 12. After forming the packaging, the packaging and the graphical indicia formed thereon are inspected. If there continues to be any unintended distortions in the graphical image, additional adjustments to the already adjusted graphical image and screen transfer thereof can be made 32 as required, in one or more iterations, as is necessary to achieve the intended results. Thereafter, mass production of the packaging with graphical indicia formed thereon may begin. Any additional trimming, die cutting and assembly of formed pieces of the packaging will be carried out after the packaging is molded.

It is possible to carry out the method without using a calibration pattern per se but to instead directly measure distortions of the graphical image on molded 3-D item and use information about the distortion to modify the graphical transfer. If so, certain steps outline below can be skipped. Also, with experience, it should be possible for designer to mathematically calculate how a flat plastic or other moldable sheet will be contorted as it is molded into a finished 3-D molded item and thereby pre-adjust the graphical indicia to at least get close to the appropriate adjusted graphical indicia to print on a moldable sheet so that when the flat sheet is molded, the image will distort back to the desired image.

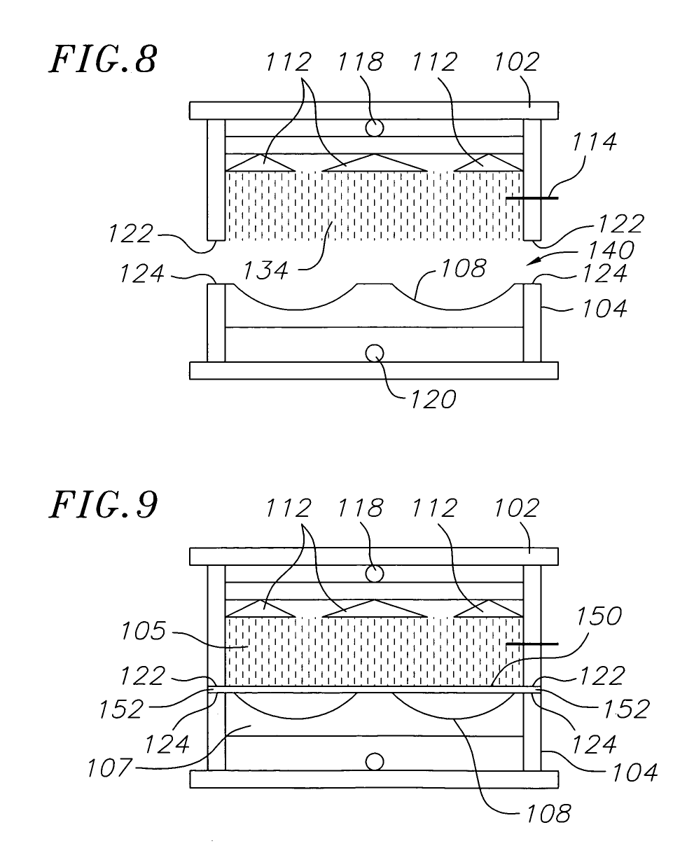

FIG. 7 is a front, partially exposed perspective view of an exemplary machine 100 for forming packaging having printing formed thereon. The machine 100 has an upper mold body 102 and a lower mold body 104 which together comprise a mold chamber 106. A mold 108 (shown as having concavities 32) is located in the lower mold body 104. The upper mold body 102 and the lower mold body 104 are moveable relative to each other from an opened position, as shown in FIG. 7, to a closed position, as shown in FIGS. 9-12 and 15-18. This opening and closing movement can be accomplished, for example, by pneumatic, hydraulic, mechanically, electromechanical cylinders 110 that extend between an upper carriage 126, to which the upper mold body 102 is attached, and a lower carriage 128, to which the lower mold body 104 is attached. The upper mold body 102 has heat sources located therein, such as infrared heat lamps 112. Other heat sources can be used in lieu of infrared lamps and the heat sources can be located in other locations. The purpose of the heat source is to provide controlled heating of the moldable sheet (not shown) so that the molded sheet will be consistently and controllably molded. A heat transfer controller 114 is also located in the upper mold body 102 and is used to measure the temperature in the mold chamber 106. This measured information is communicated to a control unit 116 which controls the heat sources and thus the temperature profile within the mold chamber 106. An air pressure/air release line 118 is in fluid communication with the upper mold body 102 and an air pressure/vacuum/air release line 120 is in fluid communication with the lower mold body 104. Depending on the particular application, the mold 108 may be movable up and down in the lower mold body 104 (as will be explained further below.) The upper mold body 102 and lower mold body 104 have facing edges 122 and 124, respectively, that are adapted to immovably retain a sheet of plastic to be molded therein (not shown) when the upper mold body 102 and lower mold body 104 are brought together such that that plastic sheet preferably provides generally air tight sealing between the upper and lower mold bodies.

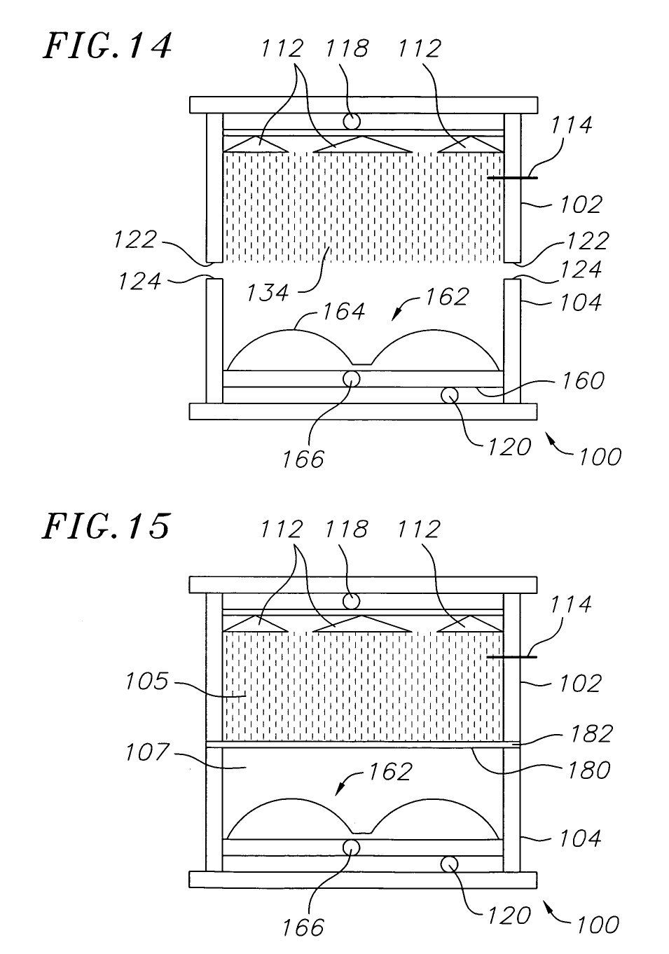

FIGS. 8-13 are cross sectional diagrammatic views illustrating the internal arrangement of the upper and lower mold bodies 102, 104 of the exemplary machine 100 of FIG. 7, used for forming concave packaging having printing formed thereon, and FIGS. 14-20 are diagrammatic cross sectional views illustrating the inside of the upper and lower mold bodies 102, 104 of the same exemplary machine 100, but being used for forming convex packaging having printing formed thereon.

Turning first to FIG. 8, the upper and lower mold bodies 102, 104 of the machine 100 is shown before a flat moldable sheet is inserted therein. The upper mold body 102 shows its heat sources 112 as being activated to give off a very even radiant heat, shown diagrammatically by the dashed area 134. The heat transfer controller 114 provides feedback to the control unit 116 (shown in FIG. 7) to control the temperature profile. For example, depending on the plastic sheet to be molded, (e.g. 0.5 mm thick PVC or PET plastic sheet) a temperature of about 90° C. and 120° C. is useful. As illustrated, the temperature should be evenly maintained in order to provide for even stretching of the printed moldable sheet. The air pressure/air release line 118 is shown in fluid communication with the upper mold body 102 and the air pressure/vacuum/air release line 120 is in fluid communication with the lower mold body 104. The facing edges 122 and 124, of the upper mold body 102 and lower mold body 104, respectively, are shown. The mold 108, having upwardly facing concavities 142 facing the upper mold portion 102, is located in the lower mold body 104 near the facing edges 124. A space 140 is available between the upper and lower mold bodies, 102 and 104, respectively, through which the sheet of flat plastic material to be molded is inserted into the machine 100.

FIG. 9 is a diagrammatic view illustrating the inside of the upper and lower mold bodies 102, 104 of the exemplary machine 100 of FIG. 8, with a flat moldable sheet 150 inserted between the machine's upper and lower molds 102, 104 and held in place by the facing edges 122 and 124, of the upper mold body 102 and lower mold body 104, respectively, compressing together around an edge 152 of the moldable sheet 150, and with heat being applied from the heating sources 112 at about 110° C. to about 120° C. for about 15 to 30 seconds, for moldable sheet comprising PVC or PET plastic sheet at about 0.5 to about 0.8 mm thick. The placement of the moldable sheet 150 between the upper mold body 102 and the lower mold body 104 will separate these two mold bodies relative to each other in terms of an upper 105 air space and a lower air space 107, the volume of each being changeable, as will be discussed further below.

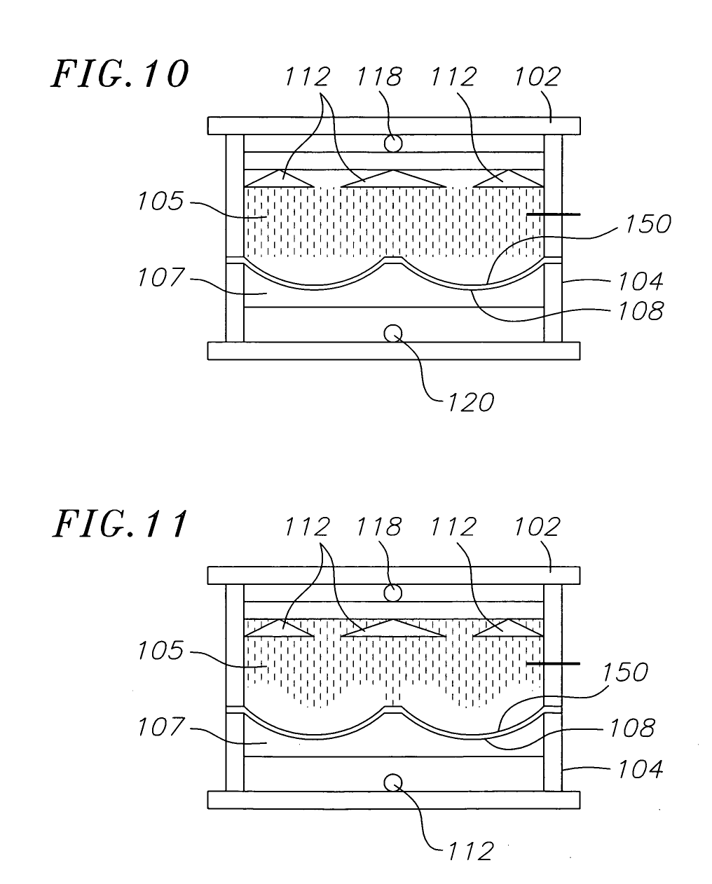

FIG. 10 is a diagrammatic view illustrating the inside of the upper and lower mold bodies 102, 104 of FIG. 9 with air pressure introduced into the upper air space 105 of the upper mold body 102 through the air pressure/air release line 118 for about 25 to 30 seconds to deform the now evenly heated and pliable flat moldable sheet 150 downwardly into general conformity to the mold 108 in the lower mold body 104. During this step, the heating sources 112 continue to maintain the upper mold body 102 at the desired temperature. The air pressure/vacuum/air release line 120 will be opened to permit any air captured in the lower air space 107 of the lower mold body 104 below the downwardly moved moldable sheet 150 to escape so as not to interfere with the even and close conforming of the molded plastic sheet 150 to the die 108. During this step, the now at least partially molded plastic sheet 150 will at least generally conform to the die 108.

FIG. 11 is a diagrammatic view illustrating the inside of the upper and lower mold bodies 102, 104 of FIG. 10 with air pressure introduced into the upper air space 105 of the upper mold 102 through the air pressure/air release line 118 and vacuum applied via the air pressure/vacuum/air release line 120 to the lower air space 107 of the lower mold 104 for about 15 to 25 seconds to completely deform the partially formed heated moldable sheet 150 into complete conformity with the die 108 in the lower mold body 104 where it is stuck closely to the die. The inventors have found that if the pressure is applied in a single step, then the heated sheet will have more deformation compared with a two step process and that furthermore, the sheet is less prone to breakage in a two step process compared to a one step process.

FIG. 12 is a diagrammatic view illustrating the inside of the upper and lower mold bodies 102, 104 of FIG. 10 with air pressure above the molded plastic sheet 150 and the vacuum below the molded plastic sheet 150 being held for some additional increment of time, after which the air pressure in the upper mold body 102 is released slowly over about 5 to 8 seconds.

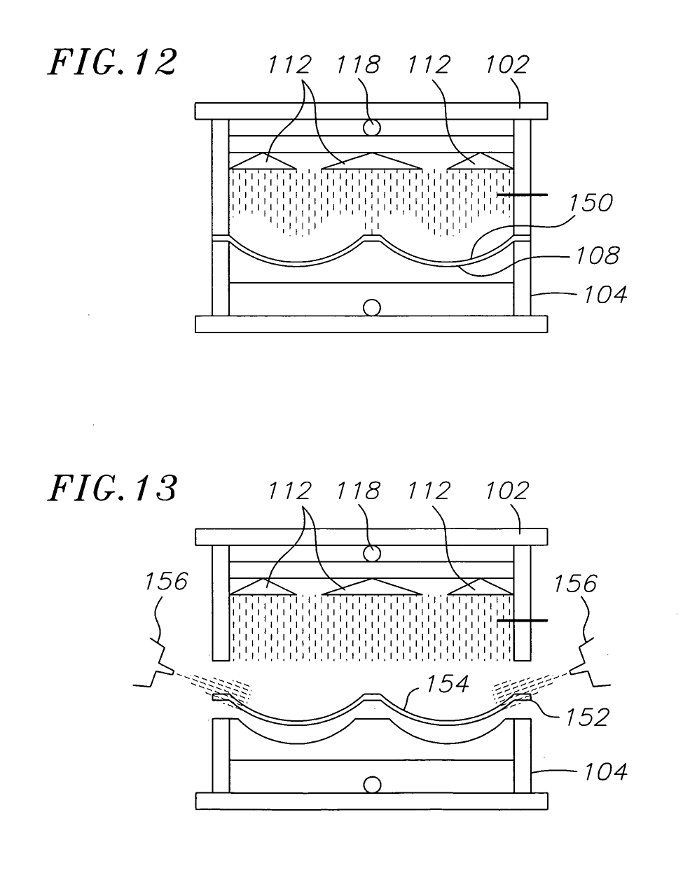

FIG. 13 is a diagrammatic view illustrating the inside of the exemplary upper and lower mold bodies 102, 104 of FIG. 10 with the upper and lower mold bodies 102 and 104, respectively, separated and air being blown on the now completely molded plastic item 154 for an increment of time, about 5 seconds in one exemplary embodiment, to cool it, via air blowers 156. During this step, the heating sources 112 can be cycled off or powered down if desired.

Thereafter, the molded plastic item 154 will be removed from the die 108 and the machine 100 and can be further processed, for example by trimming any excess material including the perimeter edge 152 of the molded plastic item 154.

FIGS. 14-20 are diagrammatic cross sectional views illustrating the inside of the exemplary upper and lower mold bodies 102, 104 of the machine 100 shown with reference to FIGS. 7-13, but here used for forming convex packaging having printing formed thereon.

FIG. 14 shows the upper and lower mold bodies 102, 104 before a flat plastic sheet is inserted therein and with its convex mold in a lowered position. In FIGS. 14-20, the upper and lower mold bodies 102, 104 are shown with the lower mold 102 having positioned therein a movable platform 160 that carries a mold 162 that has upwardly facing convexities 164 directed to the upper mold body 102. A slow air inlet hole 166 is located below the die, the purpose of which is explained below. The upper mold body 102 shows its heat sources 112 as being activated to give off a very even radiant heat, shown diagrammatically by the dashed area 134. The heat transfer controller 114 provides feedback to the control unit 116 (shown in FIG. 7) to control the temperature profile in the upper and lower mold bodies 102, 104 and thereby control the temperature and plasticity of the sheet therein. For example, depending on the moldable sheet to be molded, a temperature of about 90° C. and 120° C. is useful. As illustrated, the temperature should be evenly maintained in order to provide for even stretching of the printed moldable sheet. The air pressure/air release line 118 is shown in fluid communication with the upper mold body 102 and the air pressure/vacuum/air release line 120 is in fluid communication with the lower mold body 104. The facing edges 122 and 124, of the upper mold body 102 and lower mold body 104, respectively, are shown. The mold 162, having a generally convex profile 164, is located in the lower mold body 104 near the facing edges 124. A space 140 is available between the upper and lower mold bodies, 102 and 104, respectively, through which the sheet of flat moldable material to be molded is inserted into the machine 100.

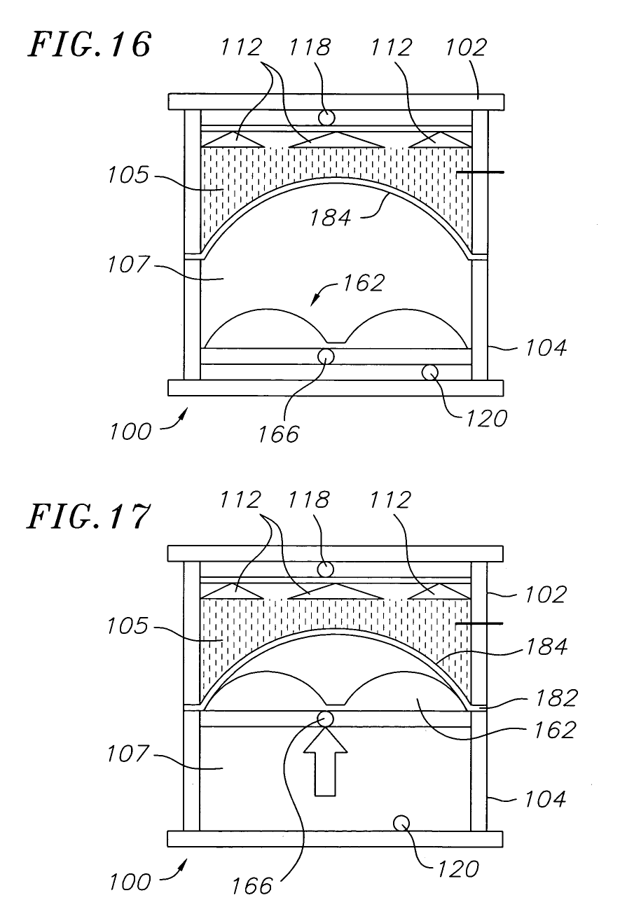

FIG. 15 is a diagrammatic view illustrating the inside of the exemplary upper and lower mold bodies 102, 104 of FIG. 14 with a flat plastic sheet 180 inserted between the machine's upper and lower molds 102 and 104, respectively, and held in place by the facing edges 122 and 124, of the upper mold body 102 and lower mold body 104, respectively, compressing together around an edge 182 of the plastic sheet 180, and with heat being applied from the heating sources 112 at about 110° C. to about 120° C. for about 15 to 30 seconds, for a plastic sheet comprising for example, PVC or PET plastic at about 0.5 to about 0.8 mm thick. The placement of the plastic sheet 180 between the upper mold body 102 and the lower mold body 104 will separate these two mold bodies relative to each other in terms of an upper air space 105 and a lower air space 107, the volume of each being changeable, as will be discussed further below.

FIG. 16 is a diagrammatic view illustrating the inside of the exemplary upper mold body 102 and lower mold body 104 of FIG. 14 with air pressure at about 0.05 to about 0.2 MPa first introduced into the lower air space 107 of the lower mold body 104 through the air pressure/vacuum/air release line 120 while the air is being released from the upper air space 105 of the upper mold body 102 through the air pressure/air release line 118 over about 15 to 30 seconds to deform the sheet of evenly heated flat plastic sheet upwardly into a generally convexly curved plastic sheet 184. During this step, the heating sources 112 continue to maintain the upper mold body 102 at the desired temperature so that the generally convexly arched configuration 184 is maintained.

FIG. 17 is a diagrammatic view illustrating the inside of the exemplary upper mold body 102 and lower mold body 104 of FIG. 14 with the convex mold 162 on its moving platform 160 raised upwardly so it can begin to make contact with the convexly curved plastic sheet 184 (e.g., near where the convexly curved plastic sheet 182 is held in place.) During this time, air is continued to be blow through the slow air pipe 166 to blow the sheet of material upwardly to avoid the top of the sheet from prematurely making contact with the mold 162, since if this happens too early, in certain areas the plastic sheet may be harder and thicker than the rest of the areas, and cause irregular and uncompensated deformation of the graphical indicia. At the same time, a vacuum as low as about −0.085 Mpa is applied to the lower mold body 104 via the air pressure/vacuum/air release line 120. During this time, air in the upper mold body 102 should be keep even or even increased to about 0.4 to about 0.5 MPa.

Turning now to FIG. 18, there is shown a diagrammatic view illustrating the inside of the upper mold body 102 and lower mold body 104 of FIG. 14 with the convexly curved plastic sheet 184 starting to be drawn into general contact with the convexly curved mold 162, with results in the range of about 95% conformity being achieved, to achieve nearly formed molded plastic item 186. After general conformity of the plastic sheet 186 with the mold 162 is achieved, hot pressurized air is introduced through the air pressure/air release line 118 into the upper air space 105 while vacuum is continued to be applied to the lower mold body 104 via the air pressure/vacuum/air release line 120 to further press the plastic sheet onto the die 162 to achieve even more complete conformity of the molded plastic item 188 to the mold. The pressure is maintained for about 5 to 10 seconds.

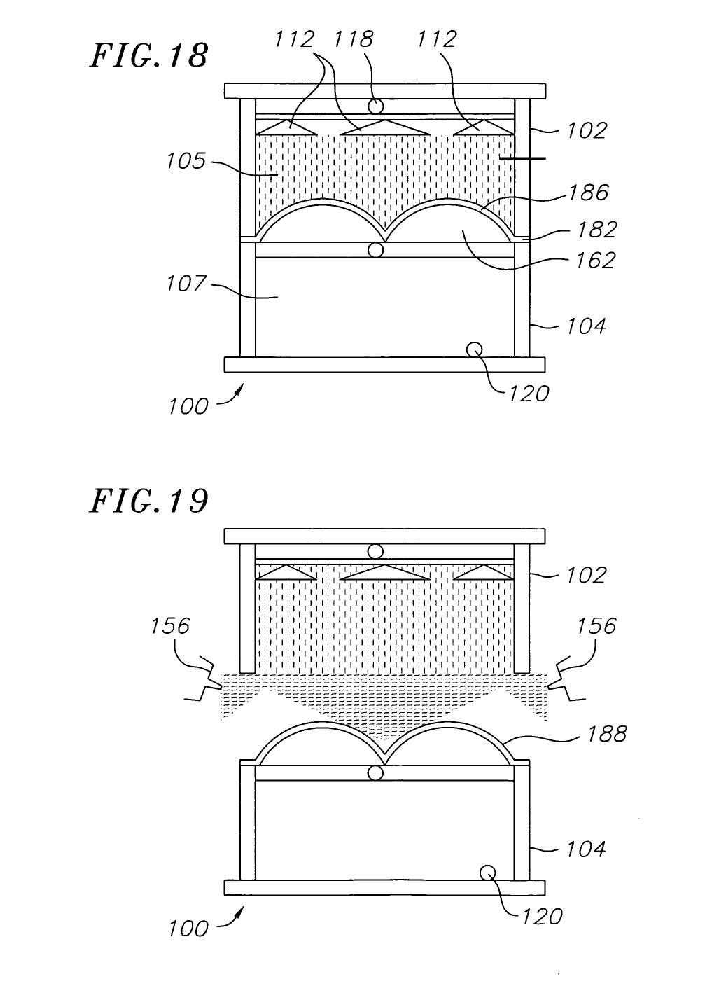

FIG. 19 is a diagrammatic view illustrating the inside of the exemplary upper mold body 102 and lower mold body 104 of FIG. 18 after the completely molded plastic sheet 180 is completely conformed to the mold 162 to form the completed molded plastic item 188, air being released from the upper mold body 102 relatively slowly, e.g., 5 seconds, through the air pressure/air release line 118 and with the upper and lower mold bodies 102, 104 separated and air being blown on the now completely molded plastic item 188 by air blowers 156, for example, for about 5 to 8 seconds to cool the completely molded plastic item 188.

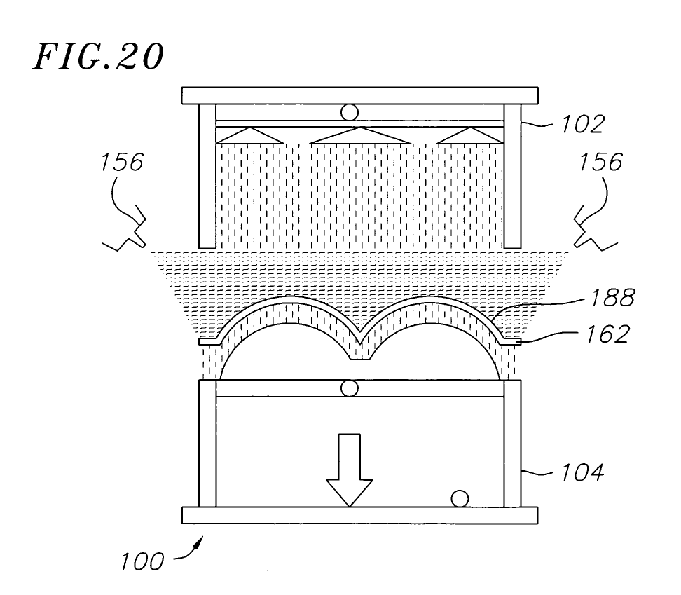

FIG. 20 is a diagrammatic view illustrating the inside of the exemplary machine 100 of FIG. 14 with the upper and lower molds 102 and 104, respectively, completely separated and air being blown on the now completely molded plastic item 188 to cool it off. Thereafter, it may be removed and finished, for example, by trimming off any excess material.

The inventors have found that by utilizing this method and machine 100, very accurate graphics can be produced on even irregularly shaped objects without harming the print colors or quality (e.g., splotching, discoloration, fading, etc.) and without sacrificing manufacturing speeds.

The invention provides a further method for making graphic transfer for packaging and other 3-D items, particularly items with non-flat and non-cylindrical surfaces that will bear graphics and text. In this method, modified graphics are prepared and printed by the method as noted above with reference to FIGS. 1-6, but only over a portion of the flat plastic sheet. For certain parts of areas that may be subject to unusual bending or other problems during the molding process where distortion is not as predictable and/or where color and print quality may be unduly affected (“sensitive areas”), these sensitive areas are not completely printed, or are not printed at all. For example, non-sensitive areas can be printed, e.g., with background colors or patterns, etc., while the area to be printed with text, where avoiding distortion may be more important, would not be printed on the flat moldable sheet, such as plastic. Thereafter, the flat plastic sheet that is partially printed with the distorted image is molded by methods, such as vacuum forming or the method and machine disclosed with reference to FIGS. 7-20. As can be expected, the sheet that is thusly molded into the desired shape will include printed areas and unprinted sensitive areas. Printing onto the unprinted sensitive areas is completed after the molding process by tampo printing of the desired text, graphics or other images (unaltered) on the unprinted areas. By following this method, rather than requiring that everything be either printed on the flat plastics sheet (e.g., by silkscreen printing), or that the mold items be entirely tampo printed, just the sensitive areas will be tampo printed. The steps of this method comprise: providing graphical indicia which is to be applied to a 3-D item; applying the graphical indicia to a first plastic sheet that is to be used to form a prototype 3-D item; forming the prototype 3-D item from the first plastic sheet with the graphical indicia; measuring any deviations in the graphical indicia on the prototype 3-D item compared to the graphical indicia on the first plastic sheet; adjusting the graphical indicia to be printed onto a plastic sheet to compensate for deviations; printing another plastic sheet with the adjusted graphical indicia; and forming the 3-D item from the plastic sheet printed with the adjusted graphical indicia.

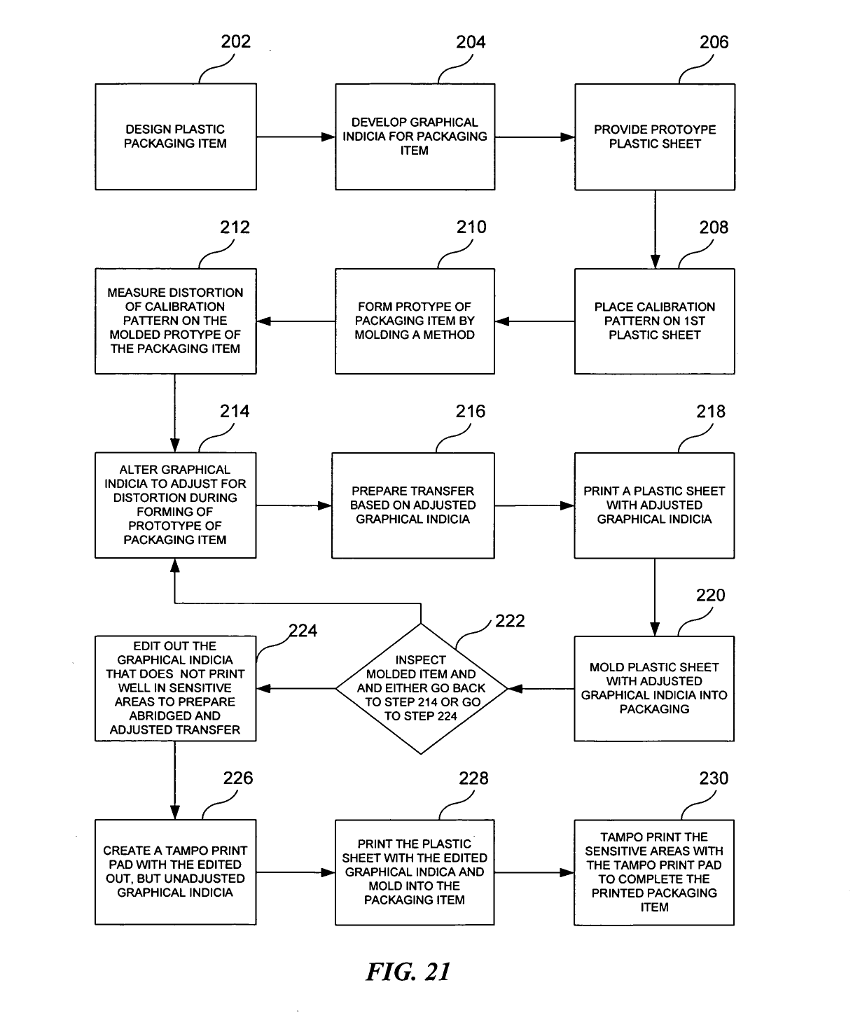

FIG. 21 is a flowchart describing this method of printing. Many of the steps are as described with reference to FIG. 1 except as noted below.

Step 1. Design the desired plastic packaging size and shape 202.

Step 2. Develop graphical indicia that is to be carried on the plastic packaging 204, as described above with reference to FIG. 1.

Referring back to FIG. 2, the packaging 40 carries graphical indicia comprising the text, “ADULT HARD CUP with supporter contoured cup” 42 and the letter “L” in a rectangle 44, both placed on graphics comprising a dark background with white lines, and a stripe 48. Additional text “ADVANCED ATHLETIC PROTECTION” 49 also appears on the packaging. As can be seen, the packaging has non-flat contours that would not be easily printable after it is formed by existing methods. Certain portions of this design, such as the area where the text will be printed could be deemed to be “sensitive areas.”

Step 3. Provide a plastic sheet 206 with suitable dimensions and characteristic, as described above with reference to FIG. 1.

Step 4. Place a calibration pattern, such as a grid of thin lines or other pattern onto a first plastic sheet as a test sheet 208, as described above with reference to FIG. 1.

Step 5. Forming the test sheet 210, e.g., by a thermoforming process, such as by a vacuum forming machine by applying the air and suction force on the test sheet 208 when it is in a heated state as described above with reference to FIG. 1, or by using the machine 100 and process described in FIGS. 7-20.

Step 6. Measure the distortion of the calibration pattern and document the distortions created by the molding process 212, as described above with reference to FIG. 1.

Step 7. The graphical indicia is altered to adjust for distortions measured in the calibration pattern in the molded packaging 214, as described above with reference to FIG. 1.

Step 8. Prepare a screen transfer based on adjustments to the distorted graphical indicia 216.

Step 9. Print by silk screen or other methods the now adjusted graphical indicia onto a plastic sheet 218, as described above with reference to FIG. 1.

Step 10. Molding the plastic sheet with the adjusted graphical indicia into the packaging 220 either by thermoforming on a vacuum forming machine as it was previously aligned when forming the test sheet, with the machine 100 of the invention as described with reference to FIGS. 7-20 below.

Step 11. After forming the packaging, the packaging and the graphical indicia formed thereon are inspected 222. If there continues to be any unintended distortions in the graphical image, the user can go back to step 7 and repeat with additional adjustment to the already adjusted graphical image and screen transfer thereof, in one or more iterations, as is necessary to achieve the intended results.

Step 12. In addition to or in lieu of following step 11, the user can choose instead to edit out the graphical indicia that does not print well in the sensitive areas and prepare an abridged and adjusted transfer that eliminates printing in the sensitive areas 226.

Step 13. A tampo print pad that is sized and shaped to print onto the sensitive areas is prepared. It will bear a transfer with the edited out, but unadjusted, graphical indicia 226.

Step 14. The flat plastic sheet is printed with abridged and adjusted transfer that eliminates printing in the sensitive areas, and this printed sheet is thereafter molded into the finished packaging item. The order of certain of the steps, e.g., steps 13 and 14, can be switched.

Step 15. The sensitive areas are printed with the tampo print pad bearing the edited out, but unadjusted graphical indicia to complete the printing. Since the tampo printing will probably be limited to smaller, more defined areas of the packaging, the tampo printing process may take place with greater ease than attempts to entirely print the packaging with tampo printing.

Thereafter, mass production of the packaging with graphical indicia formed thereon may begin. Any additional trimming, die cutting and assembly of formed pieces of the packaging will be carried out.

The above described exemplary methods are particularly useful for producing packaging that can have a much wider universe of shapes and contours since the surface of the packaging can itself carry the graphical indicia, even if the surfaces carrying the graphical indicia are neither flat nor cylindrical. While the method of the invention will function particularly well for packaging, it will also serve to create containers and other 3-D items that are to bear graphical indicia printed directly onto the surface of the plastic. The method of the invention provides a low cost way of manufacturing packaging, containers and other 3-D plastic items that directly carries graphical indicia, without the need to use decals, stickers, or printing onto odd-shaped finished goods and all the problems and expenses entailed with doing so. Indeed, after the graphical image that is to appear on the finished packaging, containers and other 3-D plastic items is adjusted to compensate for deformation during the thermoforming process and is printed on the flat plastic sheet, it may be formed by typical thermoforming steps to form the finished 3-D item.

In another embodiment of the invention, rather than providing a single sheet of plastic which is printed on its upper or lower surface, two or more sheets of plastic can be provided, with printing being placed on a upper surface of a lower sheet, a lower surface of an upper sheet, or an upper or lower surface of an intermediate sheet with overlying sheets. In the thermoforming process, the plurality of plastic sheets will become bound together and the printing will be further protected from being scratched off or abraded.

In yet a further embodiment of the method, there is provided a method of manufacturing containers, packaging or other items with graphical indicia applied thereto, wherein the containers, packaging or other items with graphical indicia applied is created in 3-D software, with the item having a 3-D virtual grid. This 3-D grid will be applied in virtual form onto the container, packaging or other item for use as a template when each new package is being created. Two grids, based on the exact surface geometry of the plastic sheet before it is formed and after it is formed into the container, packaging or other item will be made. There are currently animation software packages that allow frame by frame distortion of 3D images. This methodology to distort the graphics to exactly match the plastic shape can be used to determine the calculated distortion, and based on the calculated distortion, the graphical indicia can be adjusted.

The invention further provides a self-supporting plastic packaging, container or other 3-D item that has outer surfaces, that are non-flat and non-cylindrical which bear finished graphical indicia that were directly printed in an adjusted form onto the plastic material used to form the plastic packaging, container or other 3-D item. This self-supporting plastic packaging, container or other 3-D item can be formed from one or more sheets of flat plastic printed with adjusted graphical indicia, which one or more sheets of flat plastic will, when formed into the completed self-supporting packaging, container or other 3-D item, display the intended graphical indicia as desired. The self-supporting plastic packaging, container or other 3-D item is economically manufactured by the exemplary method described above.

Having thus described exemplary embodiments of the present invention, it should be understood by those skilled in the art that the above disclosures are exemplary only and that various other alternatives, adaptations and modifications may be made within the scope of the present invention. The presently disclosed embodiments are to be considered in all respects as illustrative and not restrictive.

What is claimed is:

1. A method of forming a 3-D item having printing formed thereon, comprising, not necessarily in the following order:
providing graphical indicia which is to be applied to a 3-D item;
providing a first moldable sheet which is to appear on a prototype of the 3-D item;
applying a calibration pattern to the first moldable sheet;
forming a prototype of the 3-D item on a mold from the first moldable sheet with the calibration pattern;
measuring deviations in the calibration pattern on the prototype 3-D item compared to the calibration pattern of the first moldable sheet,
adjusting the graphical indicia to compensate for deviations in the calibration pattern to create adjustable graphical indicia;
printing another moldable sheet with the adjusted graphical indicia; and
forming the 3-D item from the moldable sheet printed with the adjusted graphical indicia on the mold to obtain the 3-D item bearing the graphical indicia.

2. The method of claim 1, wherein the graphical indicia is in a graphic software program.

3. The method of claim 1, wherein the calibration pattern comprises spaced apart grid lines.

4. The method of claim 3, wherein the measuring of deviations in the calibration pattern of prototype item is carried out by measuring off-axis deviations of the grid lines.

5. The method of claim 1, wherein the printing of the adjusted graphical indicia is accomplished by silkscreen printing.

6. The method of claim 1, wherein the applying of the calibration pattern to the first moldable sheet is carried out by one of manually marking and printing the first moldable sheet.

7. The method of claim 1, wherein the adjusting of the graphical indicia to adjust for deviations of the calibration pattern of the prototype item is carried out by computer software and comprises shrinking areas of the graphical indicia that become stretched during the forming of the 3-D item and stretching areas of the graphical indicia that shrink during the forming of the 3-D item.

8. The method of claim 1, wherein after the 3-D item is formed from the moldable sheet with the adjusted graphical indicia, the 3-D item is inspected and if the adjusted graphical indicia has not been molded back to the graphical indicia, further adjusting the adjusted graphical indicia before the adjusted graphical indicia is printed on another moldable sheet and is formed into the 3-D item.

9. The method of claim 1, wherein the 3-D item comprises packaging for another item.

10. The method of claim 1, wherein the forming of the prototype of the 3-D item and the 3-D item are carried out by thermoforming.

11. The method of claim 1, wherein the forming of the prototype of the 3-D item and the 3-D item are carried out by a machine that heats the moldable sheets while the moldable sheets are conformed to a mold by air pressure and vacuum.

12. The method of claim 1, wherein the 3-D item has a non-flat and non-cylindrical surface that carries at least a part of the graphical indicia.

13. The method of claim 1, wherein the first moldable sheet to be printed with the calibration pattern and the other moldable sheet to be printed with the adjusted graphical indicia are flat.

14. The method of claim 1, further comprising:
inspecting the 3-D item after it is formed from the moldable sheet with the adjusted graphical indicia, wherein if a portion of the adjusted graphical indicia has not been molded back to the graphical indicia desired, that portion of the graphic indicia is eliminated from the transfer to form abridged adjusted graphical indicia and the abridged adjusted graphical indicia is printed on another moldable sheet and is formed into the 3-D item leaving an unprinted area on 3-D item; and
forming a tampo print pad sized and shaped to print the packaging in the unprinted area with the portion of the adjusted graphical indicia that was eliminated, but in an unadjusted form, to complete the printed packaging.

15. The method of claim 1, wherein the calibration pattern comprises the graphical indicia.

16. The method of claim 1, wherein the moldable sheet comprises plastic.

17. A self-supporting plastic packaging for other items, the self-supporting plastic packaging having outer surfaces that are non-flat and non-cylindrical which bear finished graphical indicia that were directly printed in an adjusted form onto plastic sheet material used to form the self-supporting plastic packaging.

18. The self-supporting plastic packaging of claim 17, wherein the self-supporting plastic packaging is formed from at least one sheet of flat plastic which is printed with adjusted graphical indicia, which flat plastic is molded into the self-supporting packaging, which thereby distorts the adjusted graphical indicia into the finished graphical indicia.

19. A machine for forming molded 3-D items from a moldable sheet, the machine comprising:
an upper mold body;
a heating source; and
a lower mold body having a mold, wherein the upper mold body and the lower mold body are adapted to move between an opened position, where they are spaced apart, and a closed position, where the upper mold body and the lower mold body are brought together to retain a sheet of moldable material that is located between the upper mold body and the lower mold body to divide them into upper and lower airspaces;
wherein the heating source is adapted to heat the moldable sheet and cause it to become moldable, wherein by changing the relative air pressures within the upper and lower airspaces of the upper and lower mold bodies, the heated, moldable sheet will be moved into contact with the mold and conform closely thereto.

20. The machine of claim 19, wherein the upper mold body and the lower mold body have sealing surfaces that are adapted to retain the moldable sheet when the upper and lower mold bodies are brought together.

21. The machine of claim 19, further comprising a heat transfer controller to measure the temperature within the upper mold body, and a control unit to control the heating sources, to thereby evenly heat the moldable sheet.

22. The machine of claim 19, wherein the heating source is located in the upper mold body.

23. The machine of claim 19, wherein the heating source comprising infrared heating lamps.

24. The machine of claim 19, wherein the upper mold body includes an air inlet/outlet for selectively introducing pressurized air into the upper airspace and releasing air therefrom, and wherein the lower mold body includes an air inlet/outlet for selectively introducing pressurized air in the lower airspace, releasing air therefrom and applying a vacuum therein.

25. The machine of claim 19, further comprising an upper carriage to which the upper mold body is attached and a lower carriage to which the lower mold body is attached, the upper and lower carriages being moveable relatively to each other in order to move the upper and lower mold bodies between the opened and closed positions.

26. The machine of claim 19, further comprising a moveable platform that is adapted to move up and down within the lower mold body, the moveable platform carrying the mold which has convexities facing the upper mold body.

27. The machine of claim 19, wherein the upper mold body and the lower mold body have perimeter edges which engage and air tightly retain the moldable sheet when the upper and lower mold bodies are brought together.

28. The machine of claim 19, wherein the mold has concavities that face the upper mold body and the machine is used to form the moldable sheet into a 3-D item having concavities.

29. The machine of claim 19, further comprising a moveable platform that is adapted to move up and down within the lower mold body, the moveable platform carrying the mold which has convexities facing the upper mold body, wherein the machine is used to form the moldable sheet into a 3-D item having convexities.

30. The machine of claim 19, wherein the moldable sheet comprises plastic.

31. A method of forming a 3-D item having printing formed thereon using the machine of claim 19, comprising:
providing graphical indicia which is to be applied to a 3-D item;
applying the graphical indicia to a first moldable sheet that is to be used to form a prototype 3-D item;
forming the prototype 3-D item from the first moldable sheet with the graphical indicia on the mold in the machine;
measuring any deviations in the graphical indicia on the prototype 3-D item compared to the graphical indicia on the first moldable sheet;
adjusting the graphical indicia to be printed onto a moldable sheet to compensate for deviations;
printing another moldable sheet with the adjusted graphical indicia; and
forming the 3-D item from the moldable sheet printed with the adjusted graphical indicia in the machine.

32. The method of claim 31, wherein the mold has concavities that face the upper mold body, and wherein the moldable sheet is heated by the heating source, air pressure is first introduced into the upper air space to cause the heated and moldable sheet to stretch downwardly into general conformity with the mold, air is then released from the lower airspace, and vacuum is then applied to the lower airspace while air pressure is continued to be applied in the upper airspace to cause the moldable sheet to completely conform to the mold to form the 3-D item.

33. The method of claim 32, wherein after the moldable sheet is completely conformed to the mold, the upper and lower mold bodies are opened and air is blown on the 3-D item.

34. The method of claim 31, wherein the machine further comprises a moveable platform that is adapted to move up and down within the lower mold body, wherein the moveable platform carries the mold, which has convexities facing the upper mold body, and wherein the moldable sheet is heated by the heating source, air pressure is introduced into the lower airspace to cause the heated and moldable sheet to stretch upwardly and air is released from the upper airspace, the moveable platform is moved upwardly to raise the mold into partial contact with the upwardly stretched moldable sheet, vacuum is applied to the lower airspace while air is allowed to enter the upper airspace to cause the moldable sheet to be brought into general conformity with the mold, and then heated air is introduced into the upper airspace while vacuum is continued to be applied in the lower airspace to cause the moldable sheet to completely conform to the mold to form the 3-D item.

35. The method of claim 34, wherein after the moldable sheet is completely conformed to the mold, the upper and lower mold bodies are opened and air is blown on the 3-D item.

36. The method of claim 19, wherein the moldable sheet comprises plastic.
